(19) United States
(12) Patent Application Publication
(10) Pub. No.: US 2025/0379250 A1
(43) Pub. Date: Dec. 11, 2025

(54) METHOD OF MANUFACTURING ALL-SOLID-STATE BATTERY

(71) Applicant: BEILab corp., Ansan-si (KR)

(72) Inventor: Changdeuck BAE, Suwon-si (KR)

(21) Appl. No.: 18/904,098

(22) Filed: Oct. 2, 2024

(30) Foreign Application Priority Data
Jun. 11, 2024 (KR) 10-2024-0075642

(51) Int. Cl. H01M 10/0562; H01M 4/02; H01M 4/04; H01M 10/058

(52) U.S. Cl. CPC H01M 10/0562; H01M 4/0404; H01M 4/0407; H01M 4/043; H01M 10/058; H01M 2004/027; H01M 2004/028; H01M 2300/0068

(57) ABSTRACT

Disclosed is a method of manufacturing an all-solid-state battery, the method including a mixture formation step of mixing positive electrode active material powder coated with a lubricating material and electrolyte powder with each other to form a mixture, an application step of applying the mixture to a positive electrode current collector, and a pressing step of pressing the mixture and the positive electrode current collector. Pores in a positive electrode composite layer formed in the pressing step may be reduced, whereby the performance of the all-solid-state battery may be improved.

### CROSS-REFERENCE TO RELATED APPLICATIONS

This U.S. non-provisional patent application claims priority under 35 U.S.C. § 119 of Korean Patent Application No. 10-2024-0075642, filed on Jun. 11, 2024, the entire contents of which are hereby incorporated by reference.

### BACKGROUND OF THE PRESENT INVENTION

### Field of the Present Invention

The present invention relates to a method of manufacturing an all-solid-state battery, and more particularly to a method of manufacturing an all-solid-state battery capable of reducing pores between a positive electrode active material (e.g., positive electrode active material powder) and an electrolyte (e.g., electrolyte powder).

### Description of the Related Art

An all-solid-state battery is a battery in which a conventional liquid electrolyte between a positive electrode and a negative electrode is replaced by a solid electrolyte.

In a general conventional battery including a liquid electrolyte, there is the risk of fire breaking out if a positive electrode and a negative electrode come into contact with each other. Since an electrolyte of an all-solid-state battery, in which lithium ions move, is formed as a solid, however, the electrolyte and electrodes remain fixed at all times, whereby the all-solid-state battery may be normally operated without damage or explosion in the event of a disturbance.

For example, Korean Patent Application Publication No. 10-2016-0060171 (hereinafter referred to as the “prior art document”) discloses an all-solid-state battery including no binder and a method of injecting a slurry of active material into pores of a carbon structure included in a positive electrode.

However, the invention disclosed in the prior art document does not consider pores formed in a positive electrode composite (cathode composite), which is a composite of positive electrode active material powder and electrolyte powder formed by pressing the positive electrode active material powder and the electrolyte powder.

In addition, the invention disclosed in the prior art document requires a process for injecting a slurry of active material into a positive electrode having pores already formed therein and a process for drying the injected active material, which reduces mass-production efficiency of all-solid-state batteries.

Furthermore, the invention disclosed in the prior art document has the problem that the density of the electrolyte mixed with the positive electrode may be reduced, resulting in a decrease in the performance of the all-solid-state battery.

### PRIOR ART DOCUMENT

### Patent Document

Korean Patent Application Publication No. 10-2023-60171

### SUMMARY OF THE PRESENT INVENTION

The present invention has been made in view of the above problems, and it is an object of the present invention to provide a method of manufacturing an all-solid-state battery capable of reducing pores in a positive electrode composite formed by pressing positive electrode active material powder and electrolyte powder.

It is another object of the present invention to provide a method of manufacturing an all-solid-state battery capable of reducing the resistance in the all-solid-state battery and improving the performance of the all-solid-state battery by reducing the pores in the positive electrode composite.

It is a further object of the present invention to provide a method of manufacturing an all-solid-state battery capable of improving mass productivity of the all-solid-state battery.

In accordance with an aspect of the present invention, the above and other objects can be accomplished by the provision of a method of manufacturing an all-solid-state battery, the method including a mixture formation step of mixing positive electrode active material powder coated with a lubricating material and electrolyte powder with each other to form a mixture, an application step of applying the mixture to a positive electrode current collector, and a pressing step of pressing the mixture and the positive electrode current collector. In the aspect of the present invention, pores in a positive electrode composite including the mixture of the positive electrode active material powder and the electrolyte powder may be reduced by the lubricating material.

The method may further include a coating step of coating the positive electrode active material powder with the lubricating material before the mixture formation step. Consequently, the mobility (or the freedom of movement) of the electrolyte powder in the positive electrode composite may be improved. In addition, the positive electrode active material powder pre-coated with the lubricating material and the electrolyte powder only need to be pressed, whereby mass productivity may be secured.

The lubricating material may include a metal precursor and a sulfur precursor. That is, in the coating step, the metal precursor and the sulfur precursor may be chemically reacted sequentially or simultaneously on the surface of the positive electrode active material powder to coat the surface of the positive electrode active material powder. In the coating step, the metal precursor provided in the form of powder and the sulfur precursor provided in the form of powder may be mixed with the positive electrode active material powder.

The metal precursor may be a compound including at least one of molybdenum (Mo) and tungsten (W). In addition, the sulfur precursor may be a compound including sulfur(S).

The coating step may be performed in a reactor (not shown). Heat required for the chemical reaction in the coating step may be obtained through heating of the reactor. Alternatively, heat required for the chemical reaction may be obtained through heat (e.g., frictional heat) generated when the metal precursor and the sulfur precursor are mixed with the positive electrode active material powder. Of course, it is also possible to obtain heat required for the chemical reaction through both heating of the reactor and the frictional heat.

In the mixture formation step, at least one of a binder and a conductive agent may be further mixed.

The lubricating material may be made of at least one of molybdenum sulfide, tungsten sulfide, boron nitride, indium, Teflon, and graphite. Consequently, the pores may be reduced without impeding the movement of ions and electrons in the all-solid-state battery.

In the pressing step, some of the electrolyte powder may be mixed with the positive electrode active material powder and the mixture thereof may be pressed to form a positive electrode composite layer and an electrolyte layer in which the electrolyte powder is pressed may be formed on the positive electrode composite layer. Consequently, the pores in the positive electrode composite layer may be reduced by the lubricating material.

In the positive electrode composite layer, the electrolyte powder may be attached to the surface of the positive electrode active material powder in a crushed state. Consequently, the mobility (or the freedom of movement) of the electrolyte powder attached to the surface of the positive electrode active material powder may be improved by the lubricating material.

A negative electrode active material may be disposed so as to face the positive electrode active material in the state in which the electrolyte powder is interposed therebetween, and a negative electrode current collector may be disposed on the negative electrode active material.

In the pressing step, the electrolyte powder may slide around the positive electrode active material due to the lubricating material, thereby reducing the pores in the positive electrode composite.

In accordance with another aspect of the present invention, there is provided a method of manufacturing an all-solid-state battery, the method including a mixture formation step of mixing a lubricating material, positive electrode active material powder, and electrolyte powder with each other to form a mixture, an application step of applying the mixture to a positive electrode current collector, and a pressing step of pressing the mixture and the positive electrode current collector. In the other aspect of the present invention, the mobility (or the freedom of movement) of the electrolyte powder attached to the circumference of the positive electrode active material powder in a crushed state may be improved, whereby pores in a positive electrode composite may be reduced. As a result, the performance of the all-solid- state battery may be improved.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a conceptual view of an all-solid-state battery according to an embodiment of the present invention;

FIG. 2 is a view showing an embodiment of a method of pressing a positive electrode active material and an electrolyte;

FIG. 3A is a conceptual view showing pores in a positive electrode composite formed when positive electrode active material powder and electrolyte powder are pressed while FIG. 3B is a conceptual view showing pores in a positive electrode composite formed when positive electrode active material powder coated with a lubricating material and electrolyte powder are pressed;

FIG. 4 is a flowchart illustrating a method of manufacturing an all-solid-state battery according to an embodiment of the present invention; and

FIG. 5 is a flowchart illustrating a method of manufacturing an all-solid-state battery according to another embodiment of the present invention.

### DETAILED DESCRIPTION OF THE PRESENT INVENTION

Hereinafter, a method of manufacturing an all-solid-state battery according to an embodiment of the present invention will be described in detail with reference to the accompanying drawings. The accompanying drawings show exemplary forms of the present invention, which are provided for the purpose of describing the present invention in more detail and are not intended to limit the technical scope of the present invention.

In addition, identical or corresponding elements are designated by the same reference numerals irrespective of figure numbers, and a duplicate description thereof will be omitted. Furthermore, the size and shape of each element shown may be exaggerated or reduced for convenience of description.

In addition, in describing the present invention, a detailed description of related prior art will be omitted if it is determined that a detailed description of the related prior art would obscure the gist of the present invention.

FIG. 1 is a conceptual view of an all-solid-state battery according to an embodiment of the present invention.

Referring to FIG. 1, the all-solid-state battery according to the embodiment of the present invention may include a positive electrode current collector 100, a positive electrode active material 200 provided on the positive electrode current collector 100, a negative electrode active material 400 provided on the positive electrode active material 200, an electrolyte 300 provided between the positive electrode active material 200 and the negative electrode active material 400, and a negative electrode current collector 500 provided on the negative electrode active material 400.

Each of the positive electrode current collector 100 and the negative electrode current collector 500 serves to collect electrons generated by electrochemical reaction of the active material (the positive electrode active material or the negative electrode active material) or to supply electrons required for electrochemical reaction.

The positive electrode active material 200 may be provided in the form of solid powder and pressed together with the electrolyte 300 (e.g., a solid electrolyte), a description of which will follow. For example, both the positive electrode active material 200 and the electrolyte 300 may be provided in the form of solid powder, the electrolyte 300 powder may be supplied on the positive electrode active material 200 powder, the positive electrode active material 200 powder and the electrolyte 300 powder may be mixed with each other, and the mixture of the positive electrode active material 200 powder and the electrolyte 300 powder may be pressed.

The positive electrode active material 200 may be made of at least one of lithium-rich layered oxide (Li_{1-X}Ni_{X}Mn_{X}Co_{X}O₂), iron fluoride, lithium nickel phosphate (LiNiPO₄), lithium cobalt phosphate (LiCoPO₄), lithium vanadium phosphate (Li₃V₂(PO₄)₃), lithium manganese phosphate (LiMnPO₄), lithium iron phosphate (LiFePO₄), lithium nickel manganese oxide (LiNi_{X}Mn_{2-X}O₄), lithium manganese oxide (LiMn₂O₄), lithium nickel cobalt aluminum oxide (NCA, LiNi_{X}Co_{X}Al_{Y}O₂), lithium nickel manganese cobalt oxide (NMC, LiNi_{X}Mn_{Y}Co_{X}O₂), and lithium cobalt oxide (LiCoO₂), or a compound of two or more of thereof.

The electrolyte 300 may be formed as a solid and may be provided in the form of powder. That is, the solid electrolyte 300 powder may be supplied on the positive electrode active material 200 powder, and the positive electrode active material 200 powder and the electrolyte 300 powder may be pressed. At least some of the electrolyte 300 powder may be mixed in interstitial spaces of the positive electrode active material 200 powder by pressing, and the remainder of the electrolyte 300 powder may be stacked on the positive electrode active material 200 powder.

The electrolyte 300 may be made of at least one of lithium phosphorus sulfide (Li₃PS₄), lithium thiophosphate (Li₇P₃S₁₁), argyrodite-type Li₆PS₅X (X=Cl, Br, or I), lithium germanium sulfide (Li₁₀GeP₂S₁₂), lithium tin sulfide (Li₁₀SnP₂S₁₂), lithium antimony sulfide (Li₃SbS₄), lithium boron sulfide (Li₂B₆S₁₀), lithium phosphorus oxynitride (LiPON), and lithium super ionic conductor (LISICON).

The negative electrode active material 400 may be disposed on the electrolyte 300 so as to face the positive electrode active material 200. For example, the negative electrode active material 400 may be provided in the form of a solid film.

The negative electrode active material 400 may be made of lithium, silicon, graphite, or an Ag/CNT composite.

The positive electrode current collector 100 may be stacked on an outer surface of the positive electrode active material 200, and the negative electrode current collector 500 may be stacked on an outer surface of the negative electrode active material 400.

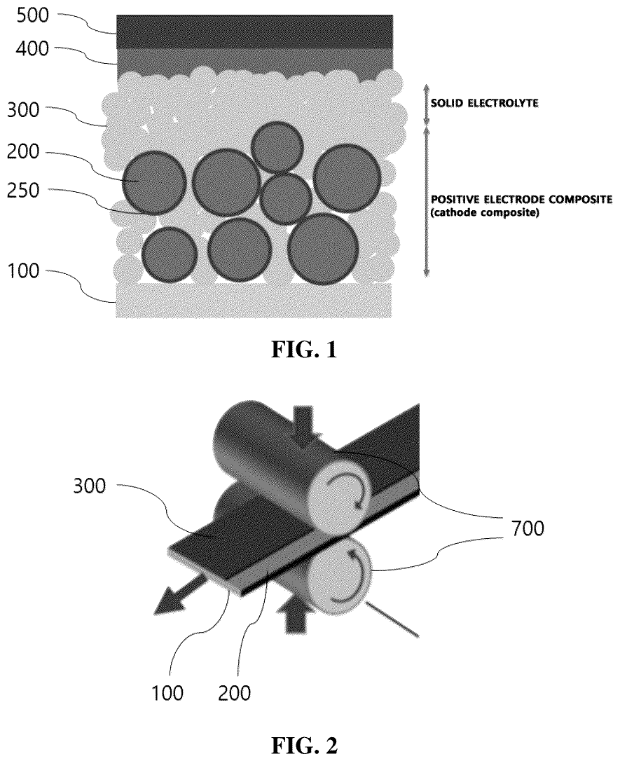

Meanwhile, pressing may be performed in the state in which the positive electrode active material 200 powder and the electrolyte 300 powder are supplied on the positive electrode current collector 100, an embodiment of which is shown in FIG. 2.

Referring to FIG. 2, in the state in which the positive electrode active material 200 powder and the electrolyte 300 powder are supplied on the positive electrode current collector 100, the positive electrode active material 200 powder and the electrolyte 300 powder on the positive electrode current collector 100 may be pressed using a pair of rollers 700. Although the layers of the positive electrode active material 200 powder and the electrolyte 300 powder are shown separately in the figure, it is also possible to supply a premixed mixture of the positive electrode active material 200 powder and the electrolyte 300 powder on the positive electrode current collector 100 and to press the same using the pair of rollers 700.

Although not shown, the mixture of the positive electrode active material 200 powder and the electrolyte 300 powder may further include at least one of a binder and a conductive agent.

For example, the binder may be polyvinyl alcohol, carboxymethylcellulose, hydroxypropylcellulose, diacetylcellulose, polyvinyl chloride, carboxylated polyvinyl chloride, polyvinyl fluoride, a polymer including ethylene oxide, polyvinylpyrrolidone, polyurethane, polytetrafluoroethylene, polyvinylidene fluoride, polyethylene, polypropylene, styrene-butadiene rubber, acrylated styrene-butadiene rubber, an epoxy resin, or nylon. One of the above examples or a mixture of two or more thereof may be used as the binder.

For example, Ketjen black, carbon black, SuperC, SuperP, carbon nanotubes (CNT), or vapor grown carbon fiber (VGCF) may be used as the conductive agent.

The binder and the conductive agent are known in the art, and therefore detailed descriptions thereof will be omitted.

While FIG. 2 shows an example of pressing the positive electrode active material 200 powder and electrolyte 300 powder on the positive electrode current collector 100 using the pair of rollers 700, other known pressing methods, such as surface pressing or vacuum pressing, may also be used in addition to pressing using rollers.

As shown in FIG. 1, when the positive electrode active material 200 powder and the electrolyte 300 powder are pressed, a positive electrode composite layer including a mixture of the positive electrode active material 200 powder and the electrolyte 300 powder may be formed. The positive electrode composite layer may be configured to have a structure in which the electrolyte 300 powder is attached to an outer circumferential surface of the positive electrode active material 200 powder in a crushed state.

A plurality of pores C, a description of which will follow, may be formed in the positive electrode composite layer, and the pores C may act as internal resistance, which may be a factor in degrading the performance of the all-solid-state battery.

In the embodiment of the present invention, the pores C may be reduced by adding a lubricating material 250 before or when the positive electrode active material 200 powder and electrolyte 300 powder are pressed.

For example, the lubricating material 250 may be made of at least one of molybdenum sulfide, tungsten sulfide, boron nitride, indium, Teflon, and graphite, or a compound of two or more thereof.

As shown in FIG. 1, in the embodiment, the positive electrode active material 200 powder may be pre-coated with the solid lubricating material 250 before the positive electrode active material 200 powder and electrolyte 300 powder are pressed.

Alternatively, in another embodiment, although not shown, the solid lubricating material 250 may be supplied in addition to the positive electrode active material 200 powder and the electrolyte 300 powder when the positive electrode active material 200 powder and the electrolyte 300 powder are pressed.

When the positive electrode active material 200 powder and the electrolyte 300 powder are pressed, the mobility (or the freedom of movement) of the electrolyte 300 powder may be increased by the lubricating material 250. That is, even if the electrolyte 300 powder is attached to the outer circumferential surface of the positive electrode active material 200 powder in a crushed state, the lubricating material 250 may allow the electrolyte 300 powder to move to fill the pores C.

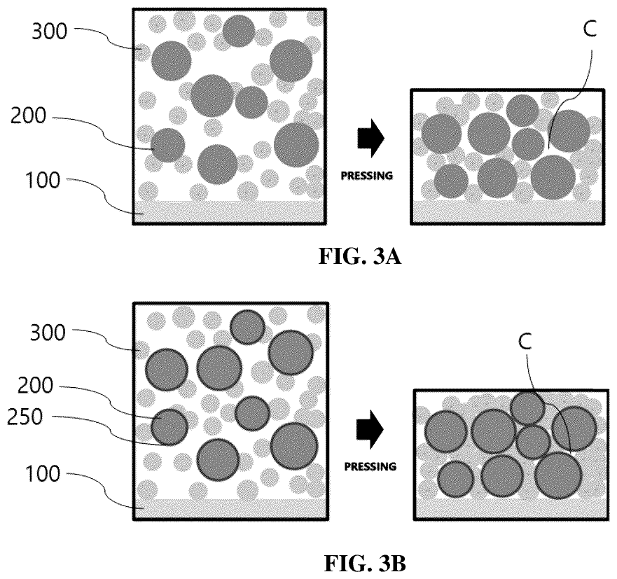

FIGS. 3A-3B are conceptual views showing the pores C formed when the positive electrode active material 200 powder and the electrolyte 300 powder are pressed without the lubricating material 250 and with the lubricating material 250 added for comparison therebetween.

Specifically, FIG. 3A is a conceptual view showing the pores in the positive electrode composite formed when the positive electrode active material powder and the electrolyte powder are pressed, and FIG. 3B is a conceptual view showing the pores in the positive electrode composite formed when the positive electrode active material powder coated with the lubricating material and the electrolyte powder are pressed.

Referring to FIG. 3A, it can be seen that, when the positive electrode active material 200 powder and the electrolyte 300 powder are pressed in the absence of the lubricating material 250, a relatively large number (a relatively large volume) of pores C is formed in the positive electrode composite (see FIG. 1) after pressing.

In contrast, referring to FIG. 3B, it can be seen that, when the lubricating material 250 is provided (e.g., when the positive electrode active material 200 powder is coated with the lubricating material 250), the number of the pores C (or the volume of the pores C) is relatively reduced.

As such, if the lubricating material 250 is provided when the positive electrode active material 200 powder and the electrolyte 300 powder are pressed (e.g., if the positive electrode active material 200 powder is coated with the lubricating material 250), the pores C in the positive electrode composite may be reduced, whereby the performance of the all-solid-state battery may be improved.

Hereinafter, a method of manufacturing an all-solid-state battery according to an embodiment of the present invention will be described with reference to other figures. In describing the method of manufacturing the all-solid-state battery, it is obvious that the configuration of the all-solid-state battery described above may be equally applied to the method of manufacturing the all-solid-state battery.

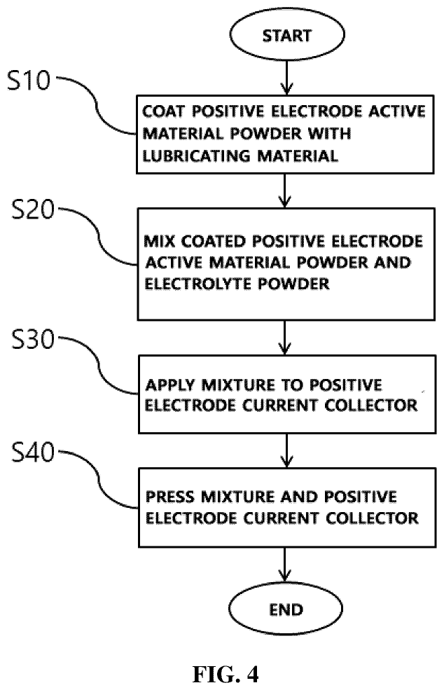

FIG. 4 is a flowchart illustrating a method of manufacturing an all-solid-state battery according to an embodiment of the present invention.

Referring to FIG. 4, the method of manufacturing the all-solid-state battery according to the embodiment of the present invention may include a mixture formation step (S20), an application step (S30), and a pressing step (S40).

In the mixture formation step (S20), positive electrode active material 200 powder coated with a lubricating material and electrolyte 300 powder may be mixed with each other to form a mixture. That is, the mixture is a mixture of the positive electrode active material 200 powder coated with the lubricating material and the electrolyte 300 powder, and the mixture may further include at least one of a binder and a conductive agent, which are already known.

In the mixture formation step (S20), the electrolyte 300 powder may be mixed with the positive electrode active material 200 powder, and at the same time the electrolyte 300 powder may be further disposed on the positive electrode active material 200 powder. That is, in the mixture formation step (S20), some of the electrolyte 300 powder may be mixed with the positive electrode active material 200 powder, and the remainder of the electrolyte 300 powder may be disposed on the positive electrode active material 200.

In the application step (S30), the mixture may be applied to a positive electrode current collector 100 provided in the form of a film. That is, the mixture may be provided on the positive electrode current collector 100 for pressing, a description of which will follow.

In the pressing step (S40), the mixture and the positive electrode current collector 100 may be pressed. That is, in the pressing step S40, the positive electrode active material 200 powder and the electrolyte 300 powder may be pressed on the positive electrode current collector 100.

Some of the electrolyte 300 powder may be introduced among the positive electrode active material 200 powder to form a positive electrode composite layer, and an electrolyte layer in which the remainder of the electrolyte 300 powder is pressed may be formed on the positive electrode composite layer.

At this time, in the positive electrode composite layer, the electrolyte 300 powder may be attached to the outer circumferential surface of the positive electrode active material 200 in a crushed state, and the mobility (or the freedom of movement) of the electrolyte 300 powder may be improved by the lubricating material 250.

That is, in the pressing step (S40), the electrolyte 300 powder may slide around the positive electrode active material 200 powder due to the lubricating material 250, thereby reducing pores in the positive electrode composite.

Consequently, the pores C in the positive electrode composite formed by pressing the positive electrode active material 200 powder and the electrolyte 300 powder may be reduced, whereby the performance of the all-solid-state battery may be improved.

In the embodiment of the present invention, a coating step (S10) may be further included before the mixture formation step (S20).

In the coating step (S10), the positive electrode active material 200 powder may be coated with the solid lubricating material 250. When the electrolyte 300 powder is attached to the outer circumferential surface of the positive electrode active material 200 powder in a crushed state, the lubricating material 250 may allow the electrolyte 300 powder to move to fill the pores.

The lubricating material may include a metal precursor and a sulfur precursor. That is, in the coating step, the surface of the positive electrode active material powder may be coated by sequential or simultaneous chemical reaction of the metal precursor and the sulfur precursor on the surface of the positive electrode active material powder. For example, metal precursor powder and sulfur precursor powder may be mixed and chemically reacted in the positive electrode active material powder.

In the coating step, the metal precursor in the form of powder and the sulfur precursor in the form of powder may be mixed with the positive electrode active material powder. For example, the chemical reaction between the metal precursor and the sulfur precursor may occur as represented by Chemical formula 1 below.

MoClₓ+2H2S->MoS2+2HCl Chemical formula 1

The metal precursor may be a compound including at least one of molybdenum (Mo) and tungsten (W). In addition, the sulfur precursor may be a compound including sulfur(S).

The coating step may be performed in a reactor (not shown). Heat required for the chemical reaction in the coating step may be obtained through heating of the reactor. Alternatively, heat required for the chemical reaction may be obtained through heat (e.g., frictional heat) generated when the metal precursor and the sulfur precursor are mixed with the positive electrode active material powder. Of course, it is also possible to obtain heat required for the chemical reaction through both heating of the reactor and the frictional heat.

A negative electrode active material 400 may be disposed so as to face the positive electrode active material 200 in the state in which the electrolyte 300 powder is interposed therebetween. The negative electrode active material 400 may be provided in the form of a film. A negative electrode current collector 500 may be disposed on the negative electrode active material 400.

In the embodiment of the present invention, therefore, the pores C in the positive electrode composite formed by pressing the positive electrode active material 200 powder and the electrolyte 300 powder may be reduced, whereby the performance of the all-solid-state battery may be improved. In addition, the mass productivity of the all-solid-state battery may be improved.

Meanwhile, in another embodiment of the present invention, the positive electrode active material 200 powder may not be pre-coated the lubricating material 250. For example, the lubricating material 250 may also be mixed when the positive electrode active material 200 powder and the electrolyte 300 powder are mixed with each other before the pressing step. Hereinafter, with reference to the other drawings, a method of manufacturing an all-solid-state battery according to another embodiment of the present invention will be described with reference to another figure.

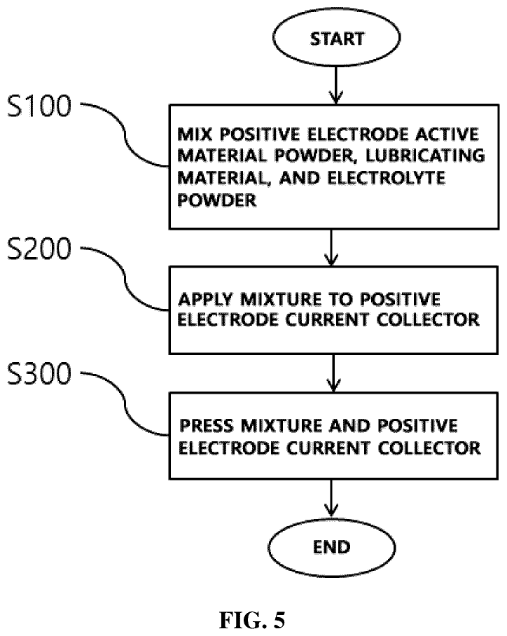

FIG. 5 is a flowchart illustrating a method of manufacturing an all-solid-state battery according to another embodiment of the present invention. This embodiment is different from the embodiment shown in FIG. 4 in that the positive electrode active material 200 powder is not pre-coated with the lubricating material 250 and the lubricating material 250 is also mixed when the positive electrode active material 200 powder and the electrolyte 300 powder are mixed with each other. The following description will focus on the differences from the embodiment of FIG. 4.

Referring to FIG. 5, the method of manufacturing the all-solid-state battery according to the other embodiment of the present embodiment may include a mixture formation step (S100), an application step (S200), and a pressing step (S300).

In the mixture formation step (S100), positive electrode active material 200 powder, electrolyte 300 powder, and a solid lubricating material 250 (or lubricating material powder) may be mixed with each other, and at the same time the electrolyte 300 powder may be further disposed on the positive electrode active material 200 powder. That is, in the mixture formation step (S100), some of the electrolyte 300 powder may be mixed with the positive electrode active material 200 powder and the lubricating material 250, and the remainder of the electrolyte 300 powder may be disposed on the positive electrode active material 200.

In the application step (S200), the mixture may be applied to a positive electrode current collector 100 provided in the form of a film. That is, the mixture may be provided on the positive electrode current collector 100 for pressing, a description of which will follow.

In the pressing step (S300), the mixture and the positive electrode current collector 100 may be pressed. That is, in the pressing step (S300), the positive electrode active material 200 powder, the electrolyte 300, and the lubricating material 250 (or the lubricating material powder) may be pressed on the positive electrode current collector 100.

Some of the electrolyte 300 powder may be introduced among the positive electrode active material 200 powder together with the lubricating material 250 to form a positive electrode composite layer, and an electrolyte layer in which the remainder of the electrolyte 300 powder is pressed may be formed on the positive electrode composite layer.

At this time, in the positive electrode composite layer, the electrolyte 300 powder may be attached to the outer circumferential surface of the positive electrode active material 200 in a crushed state, and the mobility (or the freedom of movement) of the electrolyte 300 powder may be improved by the lubricating material 250.

That is, in the pressing step (S300), the electrolyte 300 powder may slide around the positive electrode active material 200 powder due to the lubricating material 250, thereby reducing pores in the positive electrode composite.

In the other embodiment of the present invention, therefore, the pores C in the positive electrode composite formed by pressing the positive electrode active material 200 powder and the electrolyte 300 powder may be reduced, whereby the performance of the all-solid-state battery may be improved. In addition, the mass productivity of the all-solid-state battery may be improved.

According to the present invention, it is possible to provide a method of manufacturing an all-solid-state battery capable of reducing pores in a positive electrode composite formed by pressing positive electrode active material powder and electrolyte powder.

In addition, according to the present invention, it is possible to provide a method of manufacturing an all-solid-state battery capable of reducing the resistance in the all-solid-state battery and improving the performance of the all-solid-state battery by reducing the pores in the positive electrode composite.

Furthermore, according to the present invention, it is possible to provide a method of manufacturing an all-solid-state battery capable of improving mass productivity of the all-solid-state battery.

The preferred embodiment of the present invention described above is disclosed for the purpose of illustration, and those skilled in the art will appreciate that various modifications, changes, and additions are possible within the spirit and scope of the present invention and that such modifications, changes, and additions fall within the scope of the appended claims.

What is claimed is:

1. A method of manufacturing an all-solid-state battery, the method comprising:
a mixture formation step of mixing positive electrode active material powder coated with a lubricating material and electrolyte powder with each other to form a mixture;
an application step of applying the mixture to a positive electrode current collector; and
a pressing step of pressing the mixture and the positive electrode current collector.

2. The method according to claim 1, further comprising a coating step of coating the positive electrode active material powder with the lubricating material before the mixture formation step.

3. The method according to claim 2, wherein
the lubricating material comprises a metal precursor and a sulfur precursor, and
in the coating step, the metal precursor and the sulfur precursor are chemically reacted sequentially or simultaneously on a surface of the positive electrode active material powder to coat the surface of the positive electrode active material powder.

4. The method according to claim 1, wherein, in the mixture formation step, at least one of a binder and a conductive agent is further mixed.

5. The method according to claim 1, wherein the lubricating material is made of at least one of molybdenum sulfide, tungsten sulfide, boron nitride, indium, Teflon, and graphite.

6. The method according to claim 1, wherein, in the pressing step, some of the electrolyte powder is mixed with the positive electrode active material powder and a mixture thereof is pressed to form a positive electrode composite layer and an electrolyte layer in which the electrolyte powder is pressed is formed on the positive electrode composite layer.

7. The method according to claim 6, wherein, in the positive electrode composite layer, the electrolyte powder is attached to a surface of the positive electrode active material powder in a crushed state.

8. The method according to claim 1, wherein
a negative electrode active material is disposed so as to face the positive electrode active material in a state in which the electrolyte powder is interposed therebetween, and
a negative electrode current collector is disposed on the negative electrode active material.

9. The method according to claim 1, wherein, in the pressing step, the electrolyte powder slides around the positive electrode active material due to the lubricating material, thereby reducing pores in a positive electrode composite.

10. A method of manufacturing an all-solid-state battery, the method comprising:
a mixture formation step of mixing a lubricating material, positive electrode active material powder, and electrolyte powder with each other to form a mixture;
an application step of applying the mixture to a positive electrode current collector; and
a pressing step of pressing the mixture and the positive electrode current collector.
